(19) United States
(12) Patent Application Publication
(10) Pub. No.: US 2026/0119727 A1
(43) Pub. Date: Apr. 30, 2026

(54) TECHNIQUES FOR IMPLEMENTING AN AUTO-COMPLETION SYSTEM FOR MECHANICAL ASSEMBLY DESIGNS

(71) Applicant: AUTODESK, INC., San Francisco, CA (US)

(72) Inventors: Mohammadmehdi ATAEI, Toronto (CA); Hyunmin CHEONG, Toronto (CA); Justin Frank MATEJKA, Newmarket (CA); George William FITZMAURICE, Toronto (CA); Alexander TESSIER, Toronto (CA)

(21) Appl. No.: 19/224,542

(22) Filed: May 30, 2025

Related U.S. Application Data
(60) Provisional application No. 63/713,019, filed on Oct. 28, 2024.

(51) Int. Cl. G06F 30/12; G06F 30/17; G06F 30/27; G06F 111/20

(52) U.S. Cl. CPC G06F 30/12; G06F 30/17; G06F 30/27; G06F 2111/20

(57) ABSTRACT

One embodiment sets forth techniques for providing part suggestions and placements within mechanical assembly designs. According to some embodiments, the techniques can include generating, via at least one generative artificial intelligence (AI) model and based on a mechanical assembly design, a ranked list of suggested parts that are compatible to be incorporated into the mechanical assembly design; receiving a first selection of a part from among the ranked list of suggested parts; generating, via the at least one generative AI model, a plurality of suggested placement locations for the part based on the mechanical assembly design and the part; receiving a second selection of a placement location from among the plurality of suggested placement locations; generating an updated mechanical assembly design that incorporates the part based on the placement location; and rendering at least one user interface (UI) that displays at least a portion of the updated mechanical assembly design.

### CROSS-REFERENCE TO RELATED APPLICATIONS

The present application claims the benefit of U.S. Provisional Application titled, “TECHNIQUES FOR IMPLEMENTING AN ARTIFICIAL INTELLIGENCE POWERED AUTO-COMPLETION SYSTEM FOR MECHANICAL ASSEMBLY DESIGN,” filed on Oct. 28, 2024, and having Ser. No. 63/713,019. The subject matter of this related application is hereby incorporated herein by reference.

### BACKGROUND

### Field of the Various Embodiments

The present disclosure relates generally to computer science, artificial intelligence, and complex software, and, more specifically, to techniques for implementing an auto-completion system for mechanical assembly designs, including all aspects of the related hardware, software, graphical user interfaces, and algorithms associated with implementing the contemplated systems, techniques, functions, and operations set forth herein.

### Description of the Related Art

Designing a mechanical assembly that includes moving components often requires careful consideration of input parameters, output parameters, and transmission ratios. For example, in a geartrain assembly, specific input and output positions—as well as the desired transmission ratios—may be defined prior to beginning a design process of the geartrain assembly. A designer must then place each part of the geartrain assembly in the correct sequence, position, etc., to ensure that the geartrain assembly functions correctly.

Traditional approaches to designing mechanical assemblies rely heavily on repetitive, manual tasks such as selecting, positioning, and verifying each individual part. Yet, the primary objective of the designer is to achieve the specified input and output parameters and the required transmission ratios. As each part is manually selected, placed, etc., the designer must ensure that the geometry and resulting transmission ratio of that part contributes meaningfully toward target design goals. Additionally, designers must work through large parts libraries, which involves evaluating and comparing components with varying parameters.

One drawback of the foregoing approach is the need for manual selection, placement, and verification of each part in the mechanical assembly design. In mechanical systems—for example, in a geartrain assembly—important considerations include input and output characteristics at the beginning and end of the geartrain assembly. Nevertheless, intermediate components must still be individually selected and validated to ensure proper alignment and energy transfer throughout the geartrain assembly, which increases the overall complexity of design processes.

Another drawback of the foregoing approach is that the foregoing approach requires users to continuously—and manually—interact with extensive parts libraries, which can make the design process both time-consuming and error-prone. In particular, each part must be assessed for geometry, cost, compatibility, and fit within the geartrain assembly, even if such attributes have minimal impact on the overall performance of the geartrain assembly. However, as long as the final geartrain assembly meets the necessary functional criteria, the intermediary parts often hold limited significance. In that regard, requiring designers to manually configure such less-consequential components increases the likelihood of design errors and introduces unnecessary complexity in design processes.

As the foregoing illustrates, what is needed in the art are more effective techniques for designing mechanical assemblies.

### SUMMARY

One embodiment sets forth a computer-implemented method for providing part suggestions and placements within mechanical assembly designs. According to some embodiments, the method can include generating, via at least one generative artificial intelligence (AI) model and based on a mechanical assembly design, a ranked list of suggested parts that are compatible to be incorporated into the mechanical assembly design; receiving a first selection of a part from among the ranked list of suggested parts; generating, via the at least one generative AI model, a plurality of suggested placement locations for the part based on the mechanical assembly design and the part; receiving a second selection of a placement location from among the plurality of suggested placement locations; generating an updated mechanical assembly design that incorporates the part based on the placement location; and rendering at least one user interface (UI) that displays at least a portion of the updated mechanical assembly design.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques provide real-time, context-aware part suggestions during each stage of mechanical assembly design processes. Such suggestions are delivered as a dynamically ranked list, where each recommended part can be selected based on the relevance of the part to the current design state of the mechanical assembly design. The ranked list incorporates multiple factors, including geometric compatibility, cost, fit, functional compatibility, and other pertinent design constraints. By presenting ranked components alongside automated compatibility checks, the disclosed techniques eliminate the need for manual catalog browsing, which reduces the likelihood of integration errors. In addition to recommending parts, the disclosed techniques recommend optimal placement locations, orientations, etc., for the parts relative to the mechanical assembly design, thereby ensuring that each part meaningfully advances the mechanical assembly design toward target design goals. Accordingly, such recommendations significantly simplify design processes and reduce errors that often occur through manual part selection and placement approaches.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure configured to implement one or more aspects of the various embodiments.

FIG. 2 is a conceptual illustration of a workflow that can be implemented by the network infrastructure of FIG. 1, according to various embodiments.

FIGS. 3A-3C illustrate conceptual diagrams of a user interface associated with a software application executing on one of the endpoint devices of FIG. 1, according to various embodiments.

FIG. 4 illustrates a method for providing part suggestions and placements within mechanical assembly designs, according to various embodiments.

FIG. 5 is a more detailed illustration of a computing device that can implement the functionalities of the entities illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

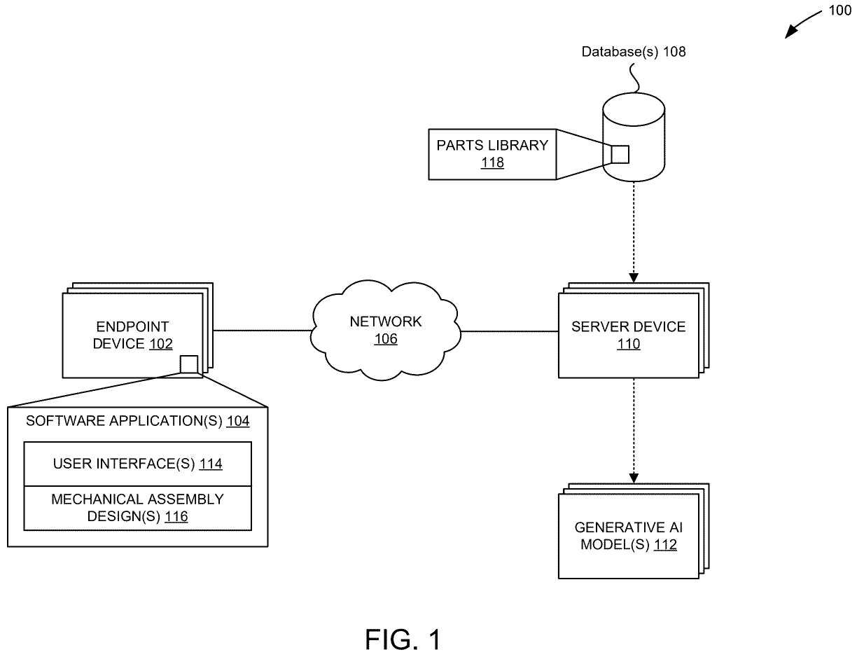

FIG. 1 illustrates a network infrastructure 100 configured to implement one or more aspects of the various embodiments. As shown, the network infrastructure 100 includes at least one endpoint device 102, at least one server device 110, at least one database 108, and at least one generative AI model 112, each of which are connected via a communications network 106. The communications network 106 can represent, for example, any technically feasible network or number of networks, including a wide area network (WAN) such as the Internet, a local area network (LAN), a Wi-Fi network, a cellular network, or a combination thereof.

According to some embodiments, the endpoint device 102 can represent a computing device (e.g., a desktop computing device, a laptop computing device, a mobile computing device, etc.). As shown in FIG. 1, the endpoint device 102 can execute, access, etc., at least one software application 104, which can implement a user interface 114 for generating, importing, interacting with, editing, etc., one or more mechanical assembly designs 116 in a software-based environment. The software application 104 can represent, for example, a web browser application, a web browser application extension, a productivity application, and the like.

According to some embodiments, a given mechanical assembly design 116 managed by the software application 104 stores information for one or more mechanical assembly designs that can be modified using the techniques described herein. As a brief aside, it should be appreciated that, while the described embodiments focus primarily on geartrain assembly designs, the techniques can be applied to any type of mechanical assembly design, consistent with the scope of this disclosure.

According to some embodiments, the software application 104 can interface with the server device 110 to access different functionalities provided by the server device 110, which can include accessing the databases 108, the generative AI models 112, and/or other entities not illustrated in FIG. 1.

According to some embodiments, the server device 110 can represent a computing device (e.g., a rack server, a blade server, a tower server, etc.). As shown in FIG. 1, the server device 110 can interface with different databases 108 that are implemented by the server device 110 and/or by other entities not illustrated in FIG. 1. As shown in FIG. 1, the databases 108 can include, for example, a parts library 118, which can represent a collection of parts that can be incorporated into the mechanical assembly designs 116. According to some embodiments, the server device 110 can enable the execution of the generative AI models 112 and/or can access generative AI models 112 that are implemented on other devices, services, etc., not illustrated in FIG. 1. According to some embodiments, and, as described herein, the generative AI models 112 can be trained to generate suggested lists of parts for the mechanical assembly designs 116, to generate suggested placement locations for selected parts within mechanical assembly designs 116, and so on.

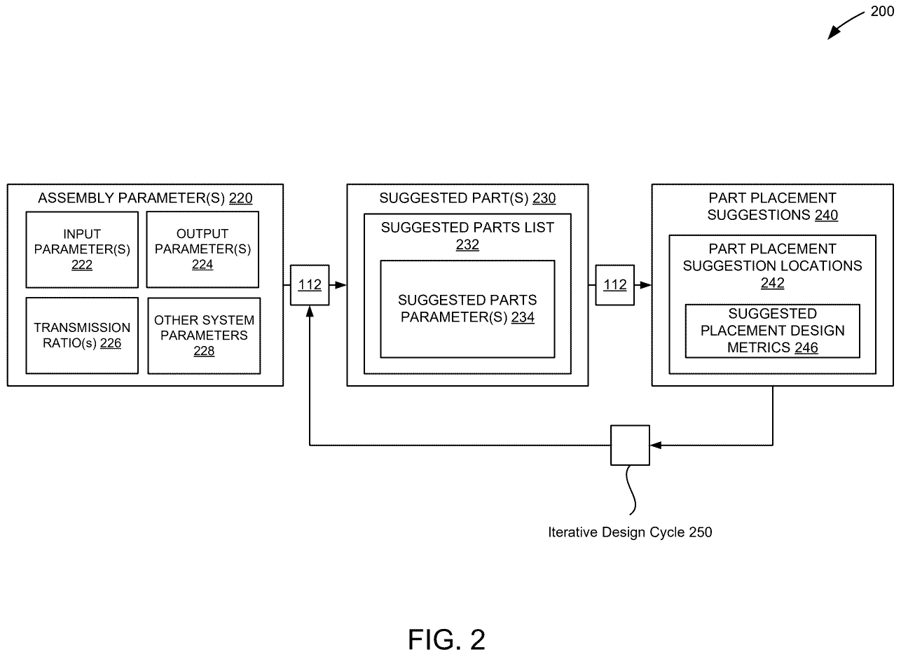

According to some embodiments, the software application 104 can enable a user to input (e.g., using voice-based inputs, text-based inputs, etc.) assembly parameters (not illustrated in FIG. 1) associated with a given mechanical assembly design 116, via one or more user interfaces 114. According to some embodiments, the assembly parameters described herein refer to a set of design objectives and constraints that define the functional and spatial constructs, goals, etc., associated with the mechanical assembly design 116. The assembly parameters can also act as guiding criteria that generative AI model 112 can use to evaluate and generate part selection and placement suggestions throughout an iterative design cycle for the mechanical assembly design 116. For example, the software application 104, via interactions with the server device 110, database 108, generative AI model(s) 112, etc., can enable the user, e.g., via one or more suggestions, to input additional parts (e.g., included in the parts library 118) into the mechanical assembly design 116. Furthermore, the software application 104 can suggest proposed locations into which the parts can be added into the mechanical assembly design 116, and can add such parts to the mechanical assembly design 116 based on specific locations selected by the user. A more detailed explanation of the functionality of the software application 104 is provided below in conjunction with FIGS. 2-4.

### Generative AI Model Overview

According to some embodiments, a given generative AI model 112 is trained on a database of parts that includes, for example, the parts included in the parts library 118. According to some embodiments, parts library 118 represents a large database of potential parts that can be incorporated into mechanical assembly designs 116. For example, the parts can include spur gears, bevel gears, shafts, worm gears, helical gears, planetary gears, pulleys, bushings, bearings, couplings, structural connectors, and the like. It is noted that the foregoing examples are not meant to be limiting, and that the parts library 118 can include any number, type, form, etc., of parts, at any level of granularity, consistent with the scope of this disclosure. In this manner, when suggesting parts to a user during the iterative design cycles described herein, generative AI model 112 can select compatible parts from parts library 118 and present the compatible parts to the user for selection.

In one example, a given generative AI model 112 can be implemented using a transformer architecture that implements a self-attention mechanism. The self-attention mechanism dynamically weights different segments of an input sequence based on contextual relevance. Unlike recurrent neural networks (RNNs)—which process sequences incrementally—the transformer architecture can attend to all positions within the input sequence simultaneously, which constitutes a simultaneous attention that enables detection of complex patterns and dependencies. Transformer architectures can include an encoder-only structure, a decoder-only structure, or an encoder-decoder structure. In some embodiments, the transformer architecture employs an encoder-decoder structure, where the encoder processes an entire input sequence, and the decoder generates an output sequence token by token. It is noted that the foregoing examples are not meant to be limiting, and that any number, type, form, etc., of generative AI model(s) 112 can be implemented, consistent with the scope of this disclosure.

In one example, generative AI model 112 includes an encoder that captures the input context, such as design constraints, objectives, and assembly parameters. At each step of generation, the decoder relies on the encoded information and previously-generated tokens to propose a distribution over all possible next tokens. A token refers to a discrete unit of information, such as a word, a symbol, or an instruction, used by generative AI model 112 to represent suggested parts, suggested locations, etc., within a design space, such as the interactive design environment provided by the software application 104.

Rather than outputting a single next token, generative AI model 112 outputs a probability distribution across a vocabulary of the generative AI model 112, where the probability distribution encodes likelihoods of various design elements being selected as subsequent tokens. In one example, the vocabulary of generative AI model 112 can include two token categories. In particular, a first category, which pertains to part selection tokens, can be used for determining parts (e.g., spur gear, bevel gear, shaft) that should appear next during an iterative design cycle for a given mechanical assembly design 116. The second category, which pertains to positioning tokens, can be used for determining placement, orientation, etc., details for a selected part to be incorporated into the mechanical assembly design 116. The generative AI model 112 can separate part selection tokens and positioning tokens such that the generative AI model 112 can perform component selection and spatial arrangement as distinct operations. In general, after a part selection token for a particular part type to be incorporated into the mechanical assembly design 116 is selected, positioning tokens can be generated to establish eligible locations into which the particular part can be placed into the mechanical assembly design 116.

A valid sequence of tokens generated by generative AI model 112 must comply with a predefined grammar. The predefined grammar enforces constraints on gear meshing, compatible gear types (e.g., spur-to-spur, bevel-to-bevel, etc.), shaft connections, interference-free assembly designs, and the like. During training, generative AI model 112 is exposed to data that conforms to the predefined grammar, thereby enabling the generative AI model 112 to generate sequences that adhere to the same structural constraints.

As each token is added, the token becomes part of the context for subsequent predictions, creating a continuous feedback loop. This iterative process continues until the generative AI model 112 completes a full design cycle or satisfies a stopping condition. A stopping condition is satisfied when the generative AI model 112 outputs a special termination token that indicates completion of an assembly sequence. In some embodiments, a stopping condition is satisfied when generative AI model 112 generates a predefined maximum number of tokens. In some embodiments, a stopping condition is satisfied when design metrics satisfy assembly parameters 220 within predefined tolerances. In some embodiments, a stopping condition is satisfied when context window capacity is reached. In some embodiments, a stopping condition is satisfied when a user halts generation via user interface 114. It is noted that the foregoing examples are not meant to be limiting, and that the stopping condition can occur based on any amount, type, form, etc., of information, at any level of granularity, consistent with the scope of this disclosure.

### Iterative Design Workflow Overview

FIG. 2 is a conceptual illustration of a workflow 200 that can be implemented by the network infrastructure of FIG. 1, according to some embodiments. As shown in FIG. 2, the workflow 200 can include, for example, assembly parameters 220, suggested parts 230, part placement suggestions 240, and generative AI models 112, which can be interconnected to implement an iterative design cycle 250. As shown in FIG. 2, the iterative design cycle 250 involves a sequence of tokens encoding spatial and part relationships being input into a generative AI model 112 during each cycle of the iterative design cycle 250 for a given mechanical assembly design 116. The generative AI model 112 outputs a probability distribution over possible parts and displays most relevant parts via the suggested parts 230. The user can select a desired part among the suggested parts 230, where, in turn, the generative AI model 112 outputs a probability distribution over possible placement locations for the selected part and displays the most relevant locations via the part placement suggestions 240. The iterative design cycle 250 process can be repeated to progressively construct the mechanical assembly design 116.

According to some embodiments, assembly parameters 220 can include input parameters 222, output parameters 224, transmission ratio(s) 226, and other system parameters 228. It is noted that the foregoing examples are not meant to be limiting, and that the assembly parameters 220 can include any amount, type, form, etc., of information, at any level of granularity, consistent with the scope of this disclosure. According to some embodiments, the suggested parts 230 can include a suggested parts list 232 and suggested part parameters 234. It is noted that the foregoing examples are not meant to be limiting, and that the suggested parts 230 can include any amount, type, form, etc., of information, at any level of granularity, consistent with the scope of this disclosure. According to some embodiments, the part placement suggestions 240 can include part placement suggestion locations 242 and suggested placement design metrics 246. It is noted that the foregoing examples are not meant to be limiting, and that the part placement suggestion locations 242 can include any amount, type, form, etc., of information, at any level of granularity, consistent with the scope of this disclosure.

As shown in FIG. 2, the conceptual workflow 200 involves receiving assembly parameters 220, e.g., via input from a user made via the user interface 114 provided by the software application 104. In turn, the generative AI model 112 generates suggested parts 230 based on the assembly parameters 220. The user can then select a suggested part from the suggested parts 230, select a different desired part not included in the suggested parts 230, and the like. Following the selection of a part, the generative AI model 112 generates part placement suggestions 240 based on the selected part and the mechanical assembly design 116. A user can select a part placement suggestion location 242 to cause the software application 104 to add the selected part to the mechanical assembly design 116 based on the selected part placement suggestion location 242.

The selection of the part, along with the placement location, constitutes completing one iteration of the iterative design cycle 250. In that regard, a single iterative of the iterative design cycle 250 enables placement of a single part within the mechanical assembly design 116 that advances the mechanical assembly design 116 toward satisfying the requirements defined through the assembly parameters 220. Additional parts can be selected for and placed within the mechanical assembly design 116, which constitutes further advancement of the iterative design cycle 250 and the mechanical assembly design 116 toward satisfying the assembly parameters 220. The iterative design cycle 250 can be repeated until the mechanical assembly design 116 satisfies the requirements defined by assembly parameters 220, until the mechanical assembly design 116 is within a predefined threshold of a combination of assembly parameters 220, and/or until other conditions are satisfied.

According to some embodiments, the software application 104 can receive the assembly parameters 220 via the user interface 114 of the software application 104. The assembly parameters 220 can include any technically feasible parameters that define a desired mechanical assembly design 116. Assembly parameters 220 can be received in various forms, including text-based input, spoken audio input converted to text-based input, selections made via user controls included in the user interface 114, and the like. It is noted that the foregoing examples are not meant to be limiting, and that the assembly parameters 220 can be provided using any number, type, form, etc., of input approach(es), at any level of granularity, consistent with the scope of this disclosure.

In an example involving a geartrain mechanical assembly design, the input parameters 222 can correspond to locations and/or orientations of input parts included in the mechanical assembly design 116, and the output parameters 224 can correspond to locations and/or orientations of output parts included in the mechanical assembly design 116. In that regard, the transmission ratio(s) 226 can correspond to one or more transmission ratios between the input part and the output part in the geartrain mechanical assembly design. Other system parameters 228 can include any technically feasible constraints for the geartrain mechanical assembly design, including, for example, a direction of power, a bounding box constraining physical dimensions of the geartrain assembly design, a load transmission requirement, motion constraints, assembly cost limits, center of mass location, and material constraints. It is noted that the foregoing examples are not meant to be limiting, and that the other system parameters 228 can include any amount, type, form, etc., of constraints, at any level of granularity, consistent with the scope of this disclosure.

After receiving the assembly parameters 220, the generative AI model 112 is utilized to generate suggested parts 230. Generative AI model 112 can generate the suggested parts 230 using various methods, including the transformer-based functionality described herein. According to some embodiments, and as described herein, the suggested parts 230 can include a suggested parts list 232, which can be automatically sorted based on the individual suitability of each part to progress the mechanical assembly design 116 toward satisfying the assembly parameters 220.

As described herein, entries within the suggested parts list 232 include suggested parts parameters 234, which include information about individual attributes for each part included in the suggested parts list 232. The suggested parts parameters 234 can include, but are not limited to, a part type, a part cost, a part price, a part weight, a part name, a part preview image, a probability percentage representing a confidence of the generative AI model 112 in a suitability of the part for advancing the design toward achieving design goals, and the like. As a result, the user can sort and filter entries in the suggested parts list 232 to prioritize selections based on specific objectives, such as minimizing the cost of the mechanical assembly design 116, reducing positional error within the mechanical assembly design 116, and the like, which enables effective navigation and refinement of the mechanical assembly design 116. It is noted that the foregoing examples are not meant to be limiting, and that the suggested parts parameters 234 can include any amount, type, form, etc., of information, at any level of granularity, consistent with the scope of this disclosure.

After selecting a part to be inserted into the mechanical assembly design 116, the generative AI model 112 is utilized to generate part placement suggestions 240. As described herein, the part placement suggestions 240 include part placement suggestion locations 242, which can indicate highest-probability locations, as determined by generative AI model 112, for placing the selected part within mechanical assembly 116.

Software application 104 overlays via user interface 114 a confidence score based on a confidence value generated by generative AI model 112 for the selected placement. Part placement suggestion locations 242 can be visually represented via semi-transparent parts displayed within the user interface 114, where each part placement suggestion location 242 is accompanied by a respective percentage score that indicates an overall strength of the placement suggestion location 242. Upon selection of a placement location, the corresponding transparent representation becomes solid, and all other placement suggestions are removed.

According to some embodiments, for each part placement suggestion location 242, the software application 104 can display suggested placement design metrics 246. According to some embodiments, the suggested placement design metrics 246 indicate how inserting the selected part at a given suggested part placement location 242 affects different design metrics of the mechanical assembly design 116. For example, if a selected part is placed above an existing series of parts, and a desired output location is in an elevated position along a Z-axis, then the suggested placement design metrics 246 can indicate an improved progression toward the assembly parameters 220 in relation to a height metric, constraint, etc. In another example, if a placement of the selected part would violate a bounding box constraint, then the placement suggestion design metrics 246 can indicate that the placement of the selected part exceeds defined spatial limits. In this manner, as various part placement suggestion locations 242 are evaluated, the user receives real-time feedback on how each theoretical placement affects different metrics associated with the mechanical assembly design 116.

After a user selects a placement of the selected part, the software application 104 inserts the selected part at the selected location and concludes a single iteration of iterative design cycle 250 for adding a part. Iterative design cycle 250 can then be repeated until different goals associated with the assembly parameters 220 are achieved.

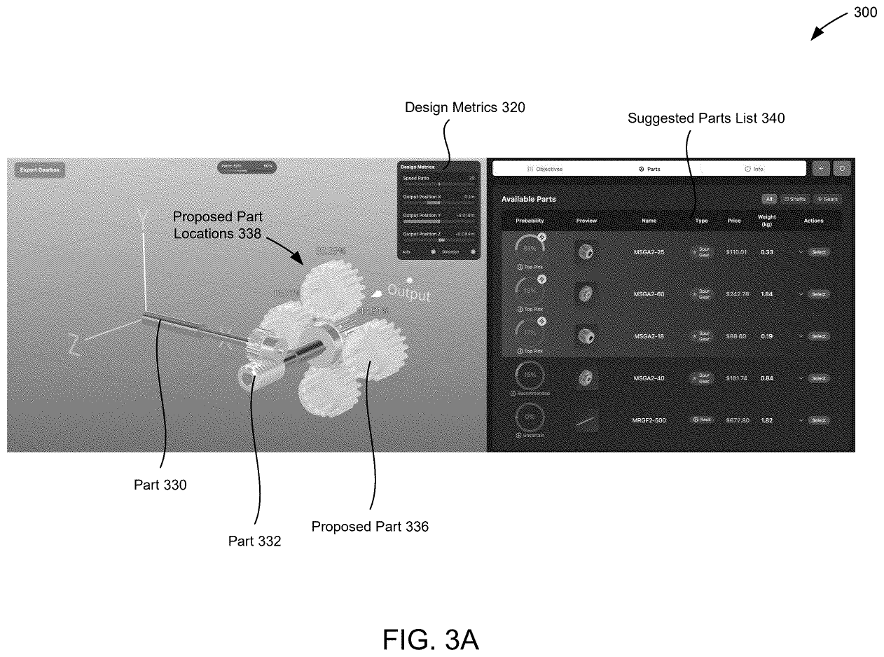

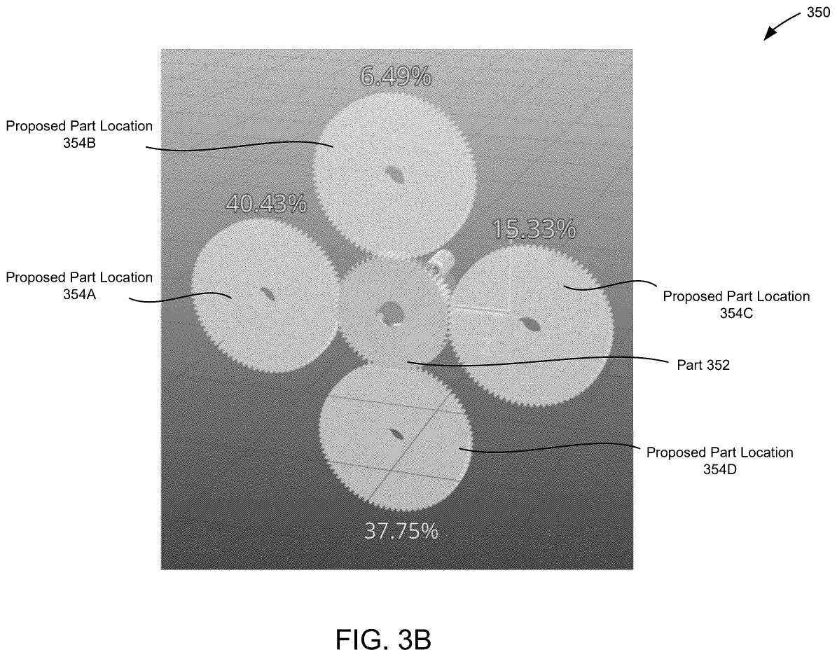

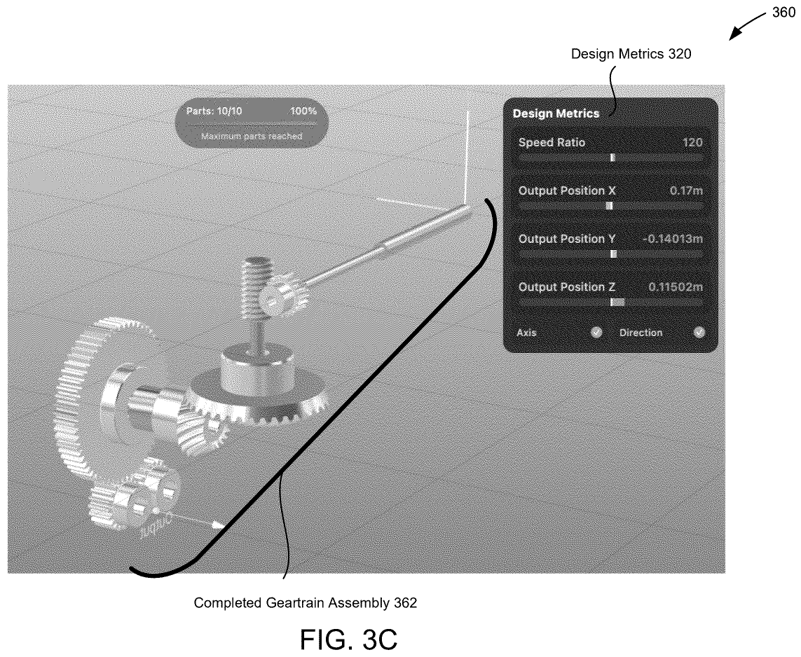

FIGS. 3A-3C illustrate conceptual diagrams of a user interface 114 implemented by a software application 104 executing on an endpoint device 102 of FIG. 1, according to various embodiments. As illustrated in FIG. 3A, a user interface 114 includes a 3D view 300 of a mechanical assembly design 116 that is being designed via the software application 104, where assembly parameters 220 have been provided for the mechanical assembly design 116. As shown in FIG. 3A, the 3D view 300 displays a part 330 position in an origin location and a part 332 that is mechanically engaged with the part 330. A proposed part 336 is shown in a semi-transparent state at four different proposed part locations 338 that represent different potential placement locations of the proposed part 336 relative to the mechanical assembly design 116.

As shown in FIG. 3A, the user interface 114 also includes a design metrics overlay 320, which displays design metrics associated with a current state of the mechanical assembly design 116. As also shown in FIG. 3A, the user interface 114 also includes a suggested parts list 340, which includes information about available, compatible, etc., parts that can be selected relative to the design of the mechanical assembly design 116.

In the example illustrated in FIG. 3A, the suggested parts list 340 includes a ranked list of available parts that is sorted based on the respective compatibility probability of each part that is based on an overall fit, function, etc., of the part relative to the mechanical assembly design 116, as determined by the software application 104. As shown in FIG. 3A, each entry in the suggested parts list 340 includes a preview image of the part, a name of the part, a type of the part, a price of the part, a weight of the part, and selectable actions associated with the part. It is noted that the foregoing examples are not meant to be limiting, and that the suggested parts list 340 can include any amount, type, form, etc., of information, for any number, type, form, etc., of part(s), at any level of granularity, consistent with the scope of this disclosure.

In an example shown in the 3D view 300, the mechanical assembly design 116 includes the part 330 and the part 332, which have already been placed into respective locations, orientations, etc., within the mechanical assembly design 116. The user has selected the proposed part 336, which corresponds to a highest-ranked entry in the suggested parts list 340. Following this selection, the software application 104 generates the four proposed part locations 338 within the mechanical assembly design 116 and into which the proposed part 336 can be compatibly placed. As shown in FIG. 3A, the user interface 114 displays, for each proposed part location 338, a respective percentage value that represents a confidence score for the proposed part location 338, as generated by a generative AI model 112, where the confidence score indicates a likelihood that placing the proposed part 336 into the proposed part locations 338 aligns with assembly parameters 220 associated with the mechanical assembly design 116.

As shown in FIG. 3A, the design metrics overlay 320 displays a current state of the mechanical assembly design 116 and how well the current state of the mechanical assembly design 116 satisfies different metrics of the assembly parameters 220. Examples of such metrics include a speed ratio, which corresponds to transmission ratio 226, as well as an offset position X, an offset position Y, and an offset position Z, which correspond to a deviation between a current assembly output location and a target output location along X, Y, and Z axes, respectively. The design metrics overlay 320 also displays alignment indicators for an axis orientation and a direction of power, which indicates whether the current state of the mechanical assembly design 116 is consistent with the specified assembly parameters 220.

Additionally, FIG. 3B illustrates a detailed view of a placement visualization 350, according to some embodiments. As shown in FIG. 3B, the placement visualization 350 includes a part 352 that is already placed, oriented, etc., within a mechanical assembly design 116. The placement visualization 350 also includes four different proposed part locations 354—specifically proposed part location 354A, proposed part location 354B, proposed part location 354C, and proposed part location 354D—which each represent compatible placement locations for a next part to be placed, oriented, etc., within the mechanical assembly design 116. As described herein, the proposed part locations 354 can be displayed in response to a selection of a part to be added to the mechanical assembly design 116.

As shown in FIG. 3B, each proposed part location 354 is represented by a respective semi-transparent instance of the part displayed in a respective position, orientation, etc., relative to the mechanical assembly design 116. As also shown in FIG. 3B, each proposed part location 354 is accompanied by a respective percentage value that corresponds to a confidence score generated by a generative AI model 112, which indicates a likelihood that placing the selected part into the proposed part location 354 will advance the design of the mechanical assembly design 116 toward the assembly parameters 220.

Additionally, FIG. 3C illustrates a user interface 114 after a design of the mechanical assembly design 116 has been completed, which is represented in FIG. 3C as a completed design cycle 360. In particular, the completed design cycle 360 includes a completed geartrain assembly 362 and design metrics 320. As shown in FIG. 3C, the completed geartrain assembly 362 includes a series of ten parts that begins at an origin and that satisfies associated assembly parameters 220 within a specified tolerance. A design metrics overlay 320 displays final performance metrics associated with the geartrain assembly 362. As shown in FIG. 3C, the design metrics 320 include a speed ratio, an output position X, an output position Y, and an output position Z. The design metrics overlay 320 also confirms that an axis orientation and a direction of power match values specified in the assembly parameters 220 associated with the mechanical assembly design 116. As further shown in FIG. 3C, the design metrics overlay 320 also indicates a deviation between desired values defined by assembly parameters 220 and actual values of the completed mechanical assembly design 116. In the example illustrated in FIG. 3C, such deviations fall within an acceptable tolerance range defined within the assembly parameters 220, so the mechanical assembly design 116 is deemed to be complete.

It is noted that the user interfaces illustrated in FIGS. 3A-3C are not meant to be limiting, and that the user interfaces can include any amount, type, form, etc., of UI element(s), at any level of granularity, consistent with the scope of this disclosure.

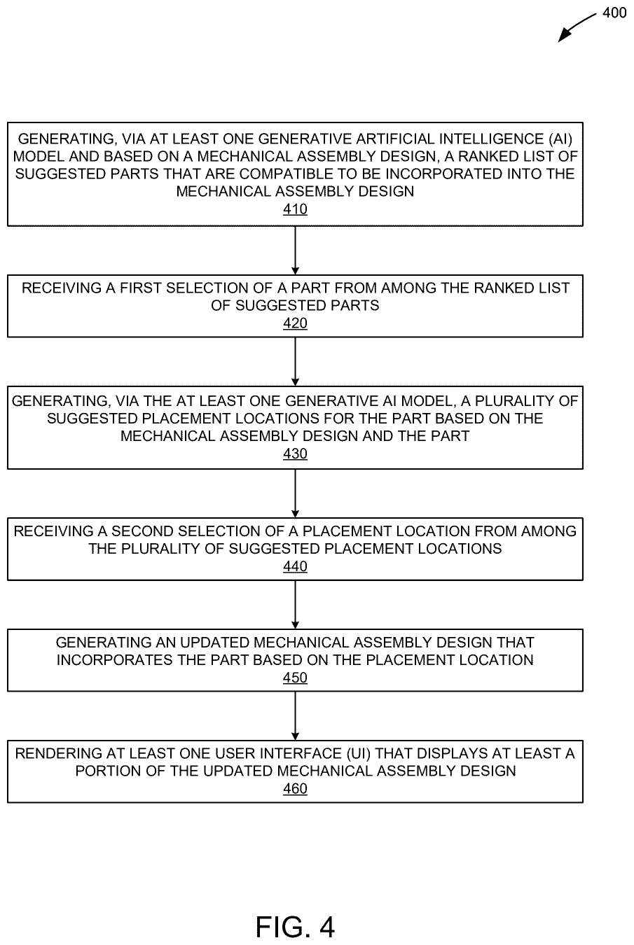

FIG. 4 illustrates a method for providing part suggestions and placements within mechanical assembly designs, according to various embodiments. As shown in FIG. 4, the method 400 begins at step 410, where the software application 104, generates, via the generative AI model 112 and based on a mechanical assembly design, a ranked list of suggested parts that are compatible to be incorporated into the mechanical assembly design (e.g., as described above in conjunction with FIGS. 1, 2, and 3A-3C).

At step 420, the software application 104 receives a first selection of a part from among the ranked list of suggested parts (e.g., as also described above in conjunction with FIGS. 1, 2, and 3A-3C). At step 430, the software application generates, via the at least one generative AI model 112, a plurality of suggested placement locations for the part based on the mechanical assembly design and the part (e.g., as also described above in conjunction with FIGS. 1, 2, and 3A-3C).

At step 440, the software application 104 receives a second selection of a placement location from among the plurality of suggested placement locations (e.g., as also described above in conjunction with FIGS. 1, 2, and 3A-3C). At step 450, the software application 104 generates an updated mechanical assembly design that incorporates the part based on the placement location (e.g., as also described above in conjunction with FIGS. 1-3). At step 460, the software application 104 renders at least one user interface (UI) that displays at least a portion of the updated mechanical assembly design (e.g., as further described above in conjunction with FIGS. 1-3).

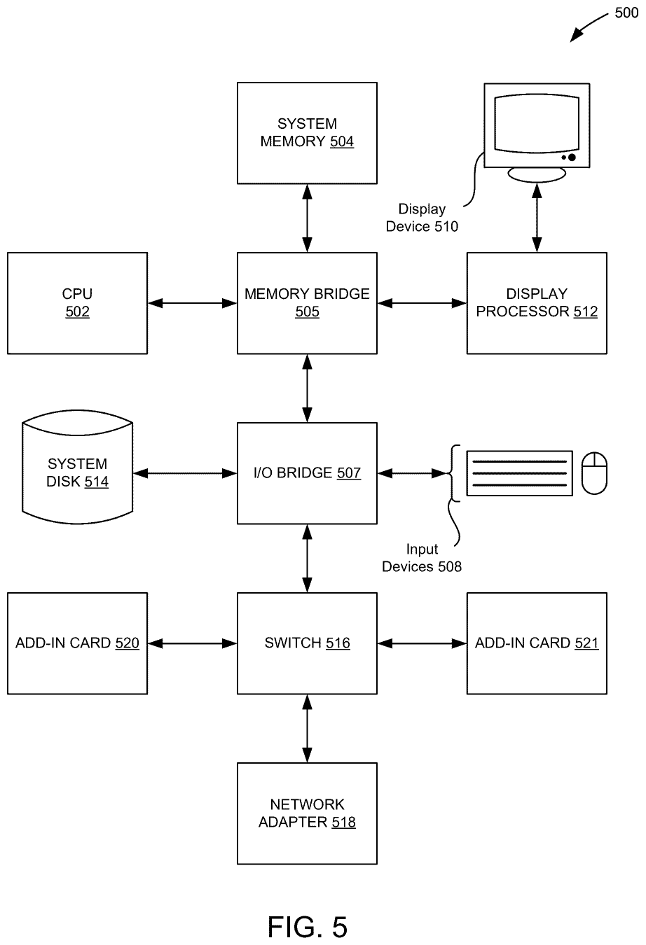

FIG. 5 is a more detailed illustration of a computing device that can implement the functionalities of the entities illustrated in FIG. 1, according to various embodiments. This figure in no way limits or is intended to limit the scope of the various embodiments. In various implementations, system 500 may be an augmented reality, virtual reality, or mixed reality system or device, a personal computer, video game console, personal digital assistant, mobile phone, mobile device or any other device suitable for practicing the various embodiments. Further, in various embodiments, any combination of two or more systems 500 may be coupled together to practice one or more aspects of the various embodiments.

As shown, system 500 includes a central processing unit (CPU) 502 and a system memory 504 communicating via a bus path that may include a memory bridge 505. CPU 502 includes one or more processing cores, and, in operation, CPU 502 is the master processor of system 500, controlling and coordinating operations of other system components. System memory 504 stores software applications and data for use by CPU 502. CPU 502 runs software applications and optionally an operating system. Memory bridge 505, which may be, e.g., a Northbridge chip, is connected via a bus or other communication path (e.g., a HyperTransport link) to an I/O (input/output) bridge 507. I/O bridge 507, which may be, e.g., a Southbridge chip, receives user input from one or more user input devices 508 (e.g., keyboard, mouse, joystick, digitizer tablets, touch pads, touch screens, still or video cameras, motion sensors, and/or microphones) and forwards the input to CPU 502 via memory bridge 505.

A display processor 512 is coupled to memory bridge 505 via a bus or other communication path (e.g., a PCI Express, Accelerated Graphics Port, or HyperTransport link); in one embodiment display processor 512 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 504.

Display processor 512 periodically delivers pixels to a display device 510 (e.g., a screen or conventional CRT, plasma, OLED, SED or LCD based monitor or television). Additionally, display processor 512 may output pixels to film recorders adapted to reproduce computer generated images on photographic film. Display processor 512 can provide display device 510 with an analog or digital signal. In various embodiments, one or more of the various graphical user interfaces set forth in FIG. 3 are displayed to one or more users via display device 510, and the one or more users can input data into and receive visual output from those various graphical user interfaces.

A system disk 514 is also connected to I/O bridge 507 and may be configured to store content and applications and data for use by CPU 502 and display processor 512. System disk 514 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 516 provides connections between I/O bridge 507 and other components such as a network adapter 518 and various add-in cards 520 and 521. Network adapter 518 allows system 500 to communicate with other systems via an electronic communications network, and may include wired or wireless communication over local area networks and wide area networks such as the Internet.

Other components (not shown), including USB or other port connections, film recording devices, and the like, may also be connected to I/O bridge 507. For example, an audio processor may be used to generate analog or digital audio output from instructions and/or data provided by CPU 502, system memory 504, or system disk 514. Communication paths interconnecting the various components in FIG. 5 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 512 incorporates circuitry optimized for graphics and video processing, including, for example, video output circuitry, and constitutes a graphics processing unit (GPU). In another embodiment, display processor 512 incorporates circuitry optimized for general purpose processing. In yet another embodiment, display processor 512 may be integrated with one or more other system elements, such as the memory bridge 505, CPU 502, and I/O bridge 507 to form a system on chip (SoC). In still further embodiments, display processor 512 is omitted and software executed by CPU 502 performs the functions of display processor 512.

Pixel data can be provided to display processor 512 directly from CPU 502. In some embodiments, instructions and/or data representing a scene are provided to a render farm or a set of server computers, each similar to system 500, via network adapter 518 or system disk 514. The render farm generates one or more rendered images of the scene using the provided instructions and/or data. These rendered images may be stored on computer-readable media in a digital format and optionally returned to system 500 for display. Similarly, stereo image pairs processed by display processor 512 may be output to other systems for display, stored in system disk 514, or stored on computer-readable media in a digital format.

Alternatively, CPU 502 provides display processor 512 with data and/or instructions defining the desired output images, from which display processor 512 generates the pixel data of one or more output images, including characterizing and/or adjusting the offset between stereo image pairs. The data and/or instructions defining the desired output images can be stored in system memory 504 or graphics memory within display processor 512. In an embodiment, display processor 512 includes 3D rendering capabilities for generating pixel data for output images from instructions and data defining the geometry, lighting shading, texturing, motion, and/or camera parameters for a scene. Display processor 512 can further include one or more programmable execution units capable of executing shader programs, tone mapping programs, and the like.

Further, in other embodiments, CPU 502 or display processor 512 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 502, display processor 512, or one or more other processing devices or any combination of these different processors.

CPU 502, render farm, and/or display processor 512 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 500 may be a robot or robotic device and may include CPU 502 and/or other processing units or devices and system memory 504. In such embodiments, system 500 may or may not include other elements shown in FIG. 5. System memory 504 and/or other memory units or devices in system 500 may include instructions that, when executed, cause the robot or robotic device represented by system 500 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 504 is connected to CPU 502 directly rather than through a bridge, and other devices communicate with system memory 504 via memory bridge 505 and CPU 502. In other alternative topologies display processor 512 is connected to I/O bridge 507 or directly to CPU 502, rather than to memory bridge 505. In still other embodiments, I/O bridge 507 and memory bridge 505 might be integrated into a single chip. The particular components shown herein are optional; for instance, any number of add-in cards or peripheral devices might be supported. In some embodiments, switch 516 is eliminated, and network adapter 518 and add-in cards 520, 521 connect directly to I/O bridge 507.

In sum, the disclosed techniques provide a computer-implemented approach for designing mechanical assemblies. The approach leverages a user interface in combination with one or more generative AI models to assist in the design process of a given mechanical assembly design. A designer inputs key parameters associated with the mechanical assembly design, including the positions of at least a first and a last part, a target transmission ratio, and a direction of power flow. Based on such inputs, a two-step iterative design cycle is implemented using the generative AI model. In the first step, the generative AI model generates a ranked list of candidate parts selected according to the current state of the mechanical assembly design and the specified design parameters. A part is selected from the ranked list of candidate parts for placement into the mechanical assembly design. In the second step, the generative AI model generates optimal placement locations for the selected part. This two-step process can be repeated as needed to incrementally build a sequence of parts that ultimately forms a complete mechanical assembly design that satisfies desired requirements and performance metrics.

At least one technical advantage of the disclosed techniques relative to the prior art is that the disclosed techniques provide real-time, context-aware part suggestions during each stage of mechanical assembly design processes. Such suggestions are delivered as a dynamically ranked list, where each recommended part can be selected based on the relevance of the part to the current design state of the mechanical assembly design. The ranked list incorporates multiple factors, including geometric compatibility, cost, fit, functional compatibility, and other pertinent design constraints. By presenting ranked components alongside automated compatibility checks, the disclosed techniques eliminate the need for manual catalog browsing, which reduces the likelihood of integration errors. In addition to recommending parts, the disclosed techniques recommend optimal placement locations for the parts relative to the mechanical assembly design, thereby ensuring that each part meaningfully advances the mechanical assembly design toward target design goals. Accordingly, such recommendations significantly streamline the design process and reduce the errors that often occur through manual part selection and placement approaches.
1. In some embodiments, a computer-implemented method for providing part suggestions and placements within mechanical assembly designs comprises generating, via at least one generative artificial intelligence (AI) model and based on a mechanical assembly design, a ranked list of suggested parts that are compatible to be incorporated into the mechanical assembly design; receiving a first selection of a part from among the ranked list of suggested parts; generating, via the at least one generative AI model, a plurality of suggested placement locations for the part based on the mechanical assembly design and the part; receiving a second selection of a placement location from among the plurality of suggested placement locations; generating an updated mechanical assembly design that incorporates the part based on the placement location; and rendering at least one user interface (UI) that displays at least a portion of the updated mechanical assembly design.
2. The computer-implemented method of clause 1, wherein the mechanical assembly design includes a plurality of operating parameters that includes at least one of at least one mechanical input parameter, at least one mechanical output parameter, at least one bounding box, or at least one transmission ratio.
3. The computer-implemented method of clause 2, wherein the at least one mechanical input parameter includes at least one of at least one location or at least one orientation.
4. The computer-implemented method of clause 2, wherein the at least one mechanical output parameter includes at least one of at least one location, at least one orientation, or at least one direction of power.
5. The computer-implemented method of clause 2, wherein the at least one bounding box specifies at least one physical dimension of the mechanical assembly design.
6. The computer-implemented method of clause 1, further comprising displaying, via the UI, the ranked list of suggested parts, wherein the first selection of the part is received via at least one UI control associated with the part included in the UI.
7. The computer-implemented method of clause 1, further comprising displaying, via the UI, at least two suggested placement locations included in the plurality of suggested placement locations.
8. The computer-implemented method of clause 7, wherein each suggested placement location comprises a different rendering of the part relative to the suggested placement location within the UI.
9. The computer-implemented method of clause 8, wherein, for a given suggested placement location, the different rendering comprises a semi-transparent rendering of the part.
10. The computer-implemented method of clause 1, further comprising generating performance metrics associated with at least one of the part, the placement location, the mechanical assembly design, or the updated mechanical assembly design; and updating the UI to display at least a portion of the performance metrics.
11. In some embodiments, one or more non-transitory computer readable media store instructions that, when executed by one or more processors, cause the one or more processors to provide part suggestions and placements within mechanical assembly designs, by performing the operations of generating, via at least one generative artificial intelligence (AI) model and based on a mechanical assembly design, a ranked list of suggested parts that are compatible to be incorporated into the mechanical assembly design; receiving a first selection of a part from among the ranked list of suggested parts; generating, via the at least one generative AI model, a plurality of suggested placement locations for the part based on the mechanical assembly design and the part; receiving a second selection of a placement location from among the plurality of suggested placement locations; generating an updated mechanical assembly design that incorporates the part based on the placement location; and rendering at least one user interface (UI) that displays at least a portion of the updated mechanical assembly design.
12. The one or more non-transitory computer readable media of clause 11, wherein the operations further comprise displaying, via the UI, the ranked list of suggested parts, wherein the first selection of the part is received via at least one UI control associated with the part included in the UI.
13. The one or more non-transitory computer readable media of clause 11, wherein the operations further comprise displaying, via the UI, at least two suggested placement locations included in the plurality of suggested placement locations.
14. The one or more non-transitory computer readable media of clause 13, wherein each suggested placement location comprises a different rendering of the part relative to the suggested placement location within the UI.
15. The one or more non-transitory computer readable media of clause 14, wherein, for a given suggested placement location, the different rendering comprises a semi-transparent rendering of the part.
16. The one or more non-transitory computer readable media of clause 14, wherein the rendering for a suggested placement location includes an associated probability score associated with the suggested placement location of the part progressing the mechanical assembly design toward achieving operating parameters associated with the mechanical assembly design.
17. The one or more non-transitory computer readable media of clause 11, wherein the operations further comprise generating performance metrics associated with at least one of the part, the placement location, the mechanical assembly design, or the updated mechanical assembly design; and updating the UI to display at least a portion of the performance metrics.
18. The one or more non-transitory computer readable media of clause 17, wherein the performance metrics include at least one cost, output location, output orientation, or transmission ratio.
19. The one or more non-transitory computer readable media of clause 18, wherein the UI displays a visual representation of the performance metrics.
20. In some embodiments, a computer system comprises one or more memories that include instructions, and one or more processors that are coupled to the one or more memories and that, when executing the instructions, are configured to generate architectural site designs based on carbon considerations, by performing the operations of generating, via at least one generative artificial intelligence (AI) model and based on a mechanical assembly design, a ranked list of suggested parts that are compatible to be incorporated into the mechanical assembly design; receiving a first selection of a part from among the ranked list of suggested parts; generating, via the at least one generative AI model, a plurality of suggested placement locations for the part based on the mechanical assembly design and the part; receiving a second selection of a placement location from among the plurality of suggested placement locations; generating an updated mechanical assembly design that incorporates the part based on the placement location; and rendering at least one user interface (UI) that displays at least a portion of the updated mechanical assembly design.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for providing part suggestions and placements within mechanical assembly designs, the method comprising:
generating, via at least one generative artificial intelligence (AI) model and based on a mechanical assembly design, a ranked list of suggested parts that are compatible to be incorporated into the mechanical assembly design;
receiving a first selection of a part from among the ranked list of suggested parts;
generating, via the at least one generative AI model, a plurality of suggested placement locations for the part based on the mechanical assembly design and the part;
receiving a second selection of a placement location from among the plurality of suggested placement locations;
generating an updated mechanical assembly design that incorporates the part based on the placement location; and
rendering at least one user interface (UI) that displays at least a portion of the updated mechanical assembly design.

2. The computer-implemented method of claim 1, wherein the mechanical assembly design includes a plurality of operating parameters that includes at least one of at least one mechanical input parameter, at least one mechanical output parameter, at least one bounding box, or at least one transmission ratio.

3. The computer-implemented method of claim 2, wherein the at least one mechanical input parameter includes at least one of at least one location or at least one orientation.

4. The computer-implemented method of claim 2, wherein the at least one mechanical output parameter includes at least one of at least one location, at least one orientation, or at least one direction of power.

5. The computer-implemented method of claim 2, wherein the at least one bounding box specifies at least one physical dimension of the mechanical assembly design.

6. The computer-implemented method of claim 1, further comprising displaying, via the UI, the ranked list of suggested parts, wherein the first selection of the part is received via at least one UI control associated with the part included in the UI.

7. The computer-implemented method of claim 1, further comprising displaying, via the UI, at least two suggested placement locations included in the plurality of suggested placement locations.

8. The computer-implemented method of claim 7, wherein each suggested placement location comprises a different rendering of the part relative to the suggested placement location within the UI.

9. The computer-implemented method of claim 8, wherein, for a given suggested placement location, the different rendering comprises a semi-transparent rendering of the part.

10. The computer-implemented method of claim 1, further comprising:
generating performance metrics associated with at least one of the part, the placement location, the mechanical assembly design, or the updated mechanical assembly design; and
updating the UI to display at least a portion of the performance metrics.

11. One or more non-transitory computer readable media storing instructions that, when executed by one or more processors, cause the one or more processors to provide part suggestions and placements within mechanical assembly designs, by performing the operations of:
generating, via at least one generative artificial intelligence (AI) model and based on a mechanical assembly design, a ranked list of suggested parts that are compatible to be incorporated into the mechanical assembly design;
receiving a first selection of a part from among the ranked list of suggested parts;
generating, via the at least one generative AI model, a plurality of suggested placement locations for the part based on the mechanical assembly design and the part;
receiving a second selection of a placement location from among the plurality of suggested placement locations;
generating an updated mechanical assembly design that incorporates the part based on the placement location; and
rendering at least one user interface (UI) that displays at least a portion of the updated mechanical assembly design.

12. The one or more non-transitory computer readable media of claim 11, wherein the operations further comprise displaying, via the UI, the ranked list of suggested parts, wherein the first selection of the part is received via at least one UI control associated with the part included in the UI.

13. The one or more non-transitory computer readable media of claim 11, wherein the operations further comprise displaying, via the UI, at least two suggested placement locations included in the plurality of suggested placement locations.

14. The one or more non-transitory computer readable media of claim 13, wherein each suggested placement location comprises a different rendering of the part relative to the suggested placement location within the UI.

15. The one or more non-transitory computer readable media of claim 14, wherein, for a given suggested placement location, the different rendering comprises a semi-transparent rendering of the part.

16. The one or more non-transitory computer readable media of claim 14, wherein the rendering for a suggested placement location includes an associated probability score associated with the suggested placement location of the part progressing the mechanical assembly design toward achieving operating parameters associated with the mechanical assembly design.

17. The one or more non-transitory computer readable media of claim 11, wherein the operations further comprise:
generating performance metrics associated with at least one of the part, the placement location, the mechanical assembly design, or the updated mechanical assembly design; and
updating the UI to display at least a portion of the performance metrics.

18. The one or more non-transitory computer readable media of claim 17, wherein the performance metrics include at least one cost, output location, output orientation, or transmission ratio.

19. The one or more non-transitory computer readable media of claim 18, wherein the UI displays a visual representation of the performance metrics.

20. A computer system, comprising:
one or more memories that include instructions; and
one or more processors that are coupled to the one or more memories and, when executing the instructions, are configured to generate architectural site designs based on carbon considerations, by performing the operations of:
generating, via at least one generative artificial intelligence (AI) model and based on a mechanical assembly design, a ranked list of suggested parts that are compatible to be incorporated into the mechanical assembly design;
receiving a first selection of a part from among the ranked list of suggested parts;
generating, via the at least one generative AI model, a plurality of suggested placement locations for the part based on the mechanical assembly design and the part;
receiving a second selection of a placement location from among the plurality of suggested placement locations;
generating an updated mechanical assembly design that incorporates the part based on the placement location; and
rendering at least one user interface (UI) that displays at least a portion of the updated mechanical assembly design.
